(19) United States
(12) Patent Application Publication
(10) Pub. No.: US 2004/0061780 A1
(43) Pub. Date: Apr. 1, 2004

(54) Solid-state video surveillance system

(76) Inventor: David A. Huffman, Long Beach, CA (US)

Correspondence Address: BRINKS HOFER GILSON & LIONE, ONE INDIANA SQUARE, SUITE 1600, INDIANAPOLIS, IN, 46204-2033, US

(21) Appl. No.: 10/662,209

(22) Filed: Sep. 12, 2003

Related U.S. Application Data
(60) Provisional application No. 60/410,904, filed on Sep. 13, 2002.

(51) Int. Cl. H04N 7/18

(52) U.S. Cl. 348/148; 348/159

(57) ABSTRACT

A solid-state video surveillance system includes at least two video cameras and a video controller unit. The video controller unit synchronizes the operation of the video cameras such that video data may be independently generated from each of the cameras substantially in phase. The video data from each of the cameras may be merged and stored in a data file. The data file is a continuous loop such that newly stored video data continuously overwrites the oldest previously stored video data. The data file may be stored in a detachable solid state memory device.

### PRIORITY CLAIM

This application claims the benefit of U.S. Provisional Application No. 60/410,904, filed Sep. 13, 2002. The disclosure of U.S. Provisional Application No. 60/410,904, filed Sep. 13, 2002 is incorporated herein by reference.

### FIELD OF THE INVENTION

The present invention relates generally to video equipment and more particularly, to a solid-state video surveillance system.

### BACKGROUND

Video cameras that are mounted on police vehicle dashboards to aid law enforcement officers by capturing critical events are well known. The events captured by such cameras provide a valuable tool to assist law enforcement officials in the prosecution of criminal offenders. In addition, information gathered from events captured by such a video camera may lead to the capture and conviction of those that flee the scene or do harm to a police officer.

Unfortunately, the video camera systems currently available for vehicles are not a cost-effective solution for the consumer market. These systems typically cost thousands of dollars and are designed to capture events not related to accidents involving the vehicle they reside in. In addition, these systems typically only videotape the action through the front windshield.

Other vehicle-based systems designed to capture information related to accidents involving the vehicle typically don't use video, but instead record the G-forces and other diagnostic parameters such as the vehicle speed and direction. Still other vehicle-based systems for capturing vehicle accident related information do include video cameras such as those described in U.S. Pat. No. 6,262,764 to Peterson. These systems, however, are also not a cost-effective solution for consumers since such systems typically require significant amounts of hardware, data storage capacity and external communication services such as wireless communication services. In addition, installation of these systems typically consumes large amounts of space and requires significant wiring within the vehicle.

Accordingly, a need exists for a relatively simple, cost effective, easily installed and operated video surveillance system with efficient data storage.

### SUMMARY

The present invention discloses a video surveillance system. The system may be utilized in any of a number of applications, such as in vehicles, convenience stores, etc. The video surveillance system uses solid-state technology to capture video data in a continuous loop of fixed duration. The video surveillance system includes a video controller and at least two video cameras. Video data may be collected by each of the cameras.

The video controller may direct the cameras to each independently generate streams of video data that are substantially synchronized with each other and maintain a constant phase relationship. The synchronized streams of video may be merged to form a single contiguous stream of common video data representative of all of the streams of video data. The video controller may selectively alternate between the independent streams of video data from each of the cameras to interleave the video data into the stream of common video data. The single contiguous stream of common video data may be compressed and stored by the video controller in a single video data file in solid-state memory.

When installed in a vehicle, the video surveillance system may provide a history of recent events within and/or outside of the vehicle. During an event such as a rear-end collision, the video surveillance system may store video images captured independently by the video cameras in a single video file. Video images from previous to the collision, during the collision and for a determined period of time following the collision may be captured and stored. The video data captured during the event may be stored in a detachable solid state memory. The video data may subsequently be extracted from the solid state memory and loaded into an external computing device such as, a personal computer (PC). Within the external computing device, the video data may be decompressed, de-interleaved and viewed.

Further objects and advantages of the present invention will be apparent from the following description, reference being made to the accompanying drawings wherein preferred embodiments of the present invention are clearly shown.

### BRIEF DESCRIPTION OF THE DRAWINGS

FIG. 1 is perspective view of an example vehicle that includes a video surveillance system.

FIG. 2 is a block diagram of an example of the video surveillance system of FIG. 1.

FIG. 3 is a timing diagram illustrating operation of a plurality of cameras included in the video surveillance system of FIGS. 1 and 2.

FIG. 4 is a block diagram depicting an example of a portion of the video surveillance system illustrated in FIG. 2.

FIG. 5 is a timing diagram illustrating operation of a plurality of cameras that are directed by the video surveillance system of FIGS. 1 and 2.

FIG. 6 is a cutaway view of an example shock sensor illustrated in the block diagram of FIG. 2.

FIG. 7 is a process flow diagram illustrating the capture of video data by the video surveillance system of FIG. 2.

FIG. 8 is a block diagram of another example of the video surveillance system of FIG. 1.

### DETAILED DESCRIPTION OF THE PREFERRED EMBODIMENTS

The invention provides a video surveillance system. The video surveillance system allows the capture of video data in a continuous loop of fixed duration. The continuous loop may be stopped automatically based on conditions sensed by the video surveillance system to preserve the captured video data. Alternatively, the continuous loop may be stopped manually when it is desired to capture a sequence of events. The video data is efficiently captured and stored in a single video data file by synchronizing the independent generation of video data by at least two video cameras included in the video surveillance system.

The synchronized video data independently generated from each of the cameras may be interleaved to form a stream of common video data. The stream of common video data may be stored in a single video data file. The video surveillance system may be used in any application where it is desirable to capture a visual sequence of events. One example application is in a vehicle such as a passenger car. It should be noted, however, that the video surveillance system is not limited to applications involving vehicles and the following examples should not be construed as limiting the video surveillance system to only vehicular applications.

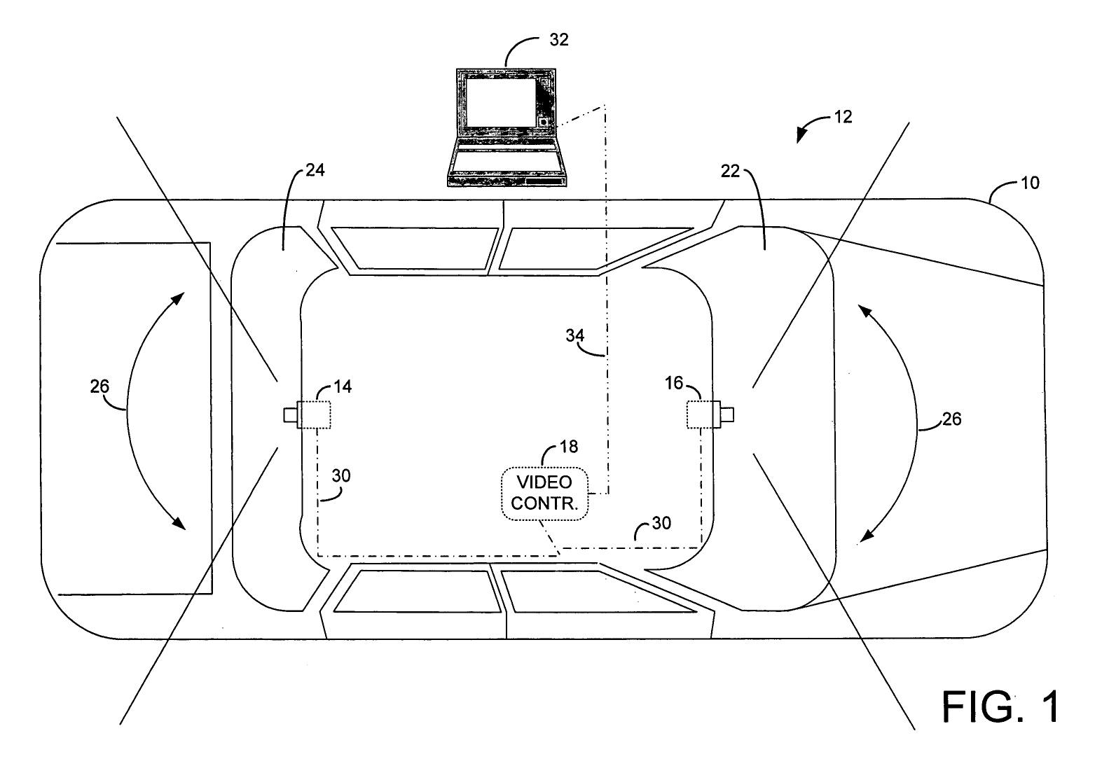

FIG. 1 is a perspective top view of an example vehicle 10 that includes the video surveillance system 12. Although depicted as a passenger vehicle, the video surveillance system 12 may also be utilized in any private or commercial vehicle such as, automobiles, motorcycles, trucks, busses, watercraft or any other mobile conveyance device. In addition, the video surveillance system 12 may be used in convenience stores, warehouses, banks, casinos or any other location where the capture of a visual sequence of events is possible.

The video surveillance system 12 includes at least two video cameras depicted as a first camera 14 and a second camera 16 and a video controller unit 18. The cameras 14 and 16 may be any device capable of independently sensing visual images and providing independent electronic signals indicative of the images in the form of a stream of video data. Example cameras include a CMOS imager and a charge coupled device (CCD) imager. Independent sensing of the visual images by the cameras 14 and 16 may include sensing images in daylight as well as in low light and/or darkness.

The cameras 14 and 16 may be positioned to capture video data for events in the vicinity surrounding the vehicle 10. In the example positions illustrated, the cameras 14 and 16 are mounted to capture video data through both the front windshield 22 and the rear window 24 of the vehicle 10. Accordingly, the cameras 14 and 16 may capture video data for front and rear impact accidents to the vehicle 10. In addition, video data useful in determining, for example, who had the “green” light when a side impact accident occurs in an intersection may be captured. In other example installations, the cameras 14 and 16 may be mounted anywhere else on the vehicle 10 to most advantageously capture events occurring in the vicinity surrounding the vehicle 10. Alternatively, the cameras 14 and 16 may be mounted to capture events inside the vehicle 10 or both inside and outside the vehicle 10.

The cameras 14 and 16 may also include a wide angle viewing capability 26. The wide angle viewing capability 26 preferably captures as much of the activity around/inside the vehicle 10 as possible. Additional cameras may also be utilized with the video surveillance system 12 and positioned elsewhere, such as to capture events occurring near the sides, bottom or top of the vehicle 10.

The electronic signals generated by the cameras 14 and 16 may be analog signals or digital signals. Analog video data signals may be provided to the video controller unit 18 on video data lines 30 by modulating the video information on to an analog video waveform such as the waveform defined in the National Television Standard Committee (NTSC) standard. Digital video data signals may be digital serial video data generated by the cameras 14 and 16. The digital serial video data may be provided to the video controller unit 18 on video data lines 30 with some type of high-speed serial interface such as Low-Voltage Differential Signaling (LVDS).

The video controller unit 18 may be any solid-state device(s) capable of directing the synchronized generation of video data by each of the cameras 14 and 16. In addition, the video controller unit 18 may perform efficient sampling, compression and storage of video data provided by the synchronous operation of the cameras 14 and 16. In other examples, the video controller unit 18 may operate with more than two cameras. The video controller unit 18 may also be capable of external event sensing, power conditioning and annunciation.

The illustrated video controller unit 18 may be positioned under the driver or passenger seat in the vehicle 10. Accordingly, the length of the video data lines 30 may be relatively short and may be efficiently routed beneath the molding in the interior of the vehicle 10. Alternatively, the video controller unit 18 may be positioned at any other location within the vehicle 10.

Communication between the video controller unit 18 and the cameras 14 and 16 may include short-range wireless communication devices. The short-range communications may include a relatively short transmission range, such as about ten feet, and may utilize standards such as WI-FL (802.1 lb). Such short-range communications may operate with transceivers of about one milli-watt of power and do not require subscription contracts, third party service providers, etc. that are typically associated with long range wireless service such as cellular telephones.

Selective communication with an external computing device such as a laptop computer 32 or any other device capable of data storage and manipulation may also be performed with the video controller unit 18. The communication may be over a wireline serial interface link 34 to allow data exchange between the video controller unit 18 and the laptop computer 32. Alternatively, communication between the laptop computer 32 and the video controller unit 18 may utilize short-range wireless communication as previously discussed. In yet another alternative, data exchange between the video controller unit 18 and an external computing device may be performed with a portable memory device such as a portable memory card.

The video controller unit 18 may also be advantageously constructed utilizing solid-state technology. Solid-state technology may provide greater resistance to damage in the vibration prone environment of a vehicle and/or in the event of a collision. In addition, solid-state devices eliminate moving parts that may be more sensitive to shock and the severe environmental conditions typically experienced in vehicles. Further, solid-state technology may be more cost effective and provide greater overall reliability than hardware performing a similar function with mechanical moving parts. Solid-state technology may also provide power conditioning functionality to generate operational voltages from power source(s) available in the vehicle 10, such as 12 VDC.

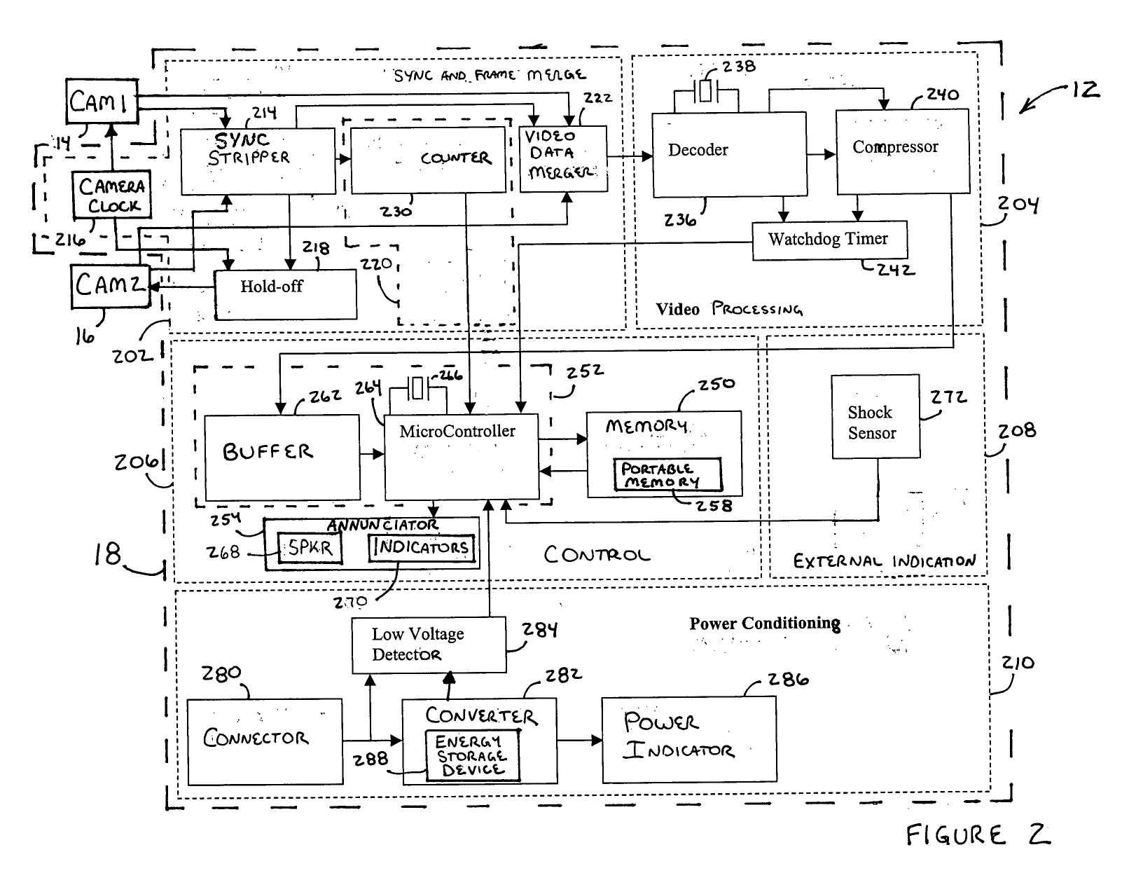

FIG. 2 is a more detailed block diagram of the video surveillance system 12 depicted in FIG. 1 that includes the first and second cameras 14 and 16 and the video controller unit 18. The illustrated example video controller unit 18 includes a sync and frame merge module 202, a video processing module 204, a control module 206, an external indication module 208 and a power conditioning module 210. The functional blocks identified in FIG. 2 are not intended to represent discrete structures and may be combined or further sub-divided in various functional block diagram examples of the video controller unit 18.

The sync and frame merge module 202 may be any mechanism(s) or device(s) capable of merging the stream of video data from each of the first and second cameras 14 and 16 to form a stream of common video data. The stream of common video data may be formed to be one contiguous stream of video data. As used herein, the term “contiguous stream of video data” or “contiguous stream of common video data” is defined as video data resembling a stream of video data from a single video data source, such as a camera. The contiguous stream of common video data may be representative of video data from both cameras 14 and 16. The stream of common video data may be formed to comply with a video standard, such as the NTSC standards, for a single contiguous stream of video data. The example sync and frame merge module 202 illustrated in FIG. 2 may be used with cameras 14 and 16 that independently generate a stream of video data as analog signals.

The illustrated sync and frame merge module 202 includes a sync stripper circuit 214, a camera clock 216, a hold-off circuit 218, a failure detection circuit 220 and a video data merger circuit 222. The sync stripper circuit 214 may extract timing information from the analog streams of video data from each of the cameras 14 and 16. The timing information may include a horizontal synchronization (Hsync) signal and a vertical synchronization (Vsync) signal. The Hsync and Vsync signals may be combined to form a composite synchronization (Csync) signal. In addition, an odd/even (OD_EV) signal may be included in the timing information and extracted by the sync stripper circuit 214.

The camera clock 216 may be any circuit or device capable of providing a common clock signal to the first camera 14 and the clock hold-off circuit 218, such as a crystal oscillator. The common clock signal is the pixel clock for both the first and second cameras 14 and 16. The clock hold-off circuit 218 may be any circuit capable of controlling application of the common clock signal to the second camera 16. The clock hold-off circuit 218 may selectively provide the common clock signal to the second camera 16 based on the timing information extracted by the sync stripper circuit 214.

The video data merger circuit 222 may be any circuit or device capable of merging the streams of video data from each of the cameras 14 and 16 to form the stream of common video data. In the illustrated example, the video data merger circuit 222 may toggle between a first stream of video data generated by the first camera 14 and a second stream of video data generated by the second camera 16. The video data merger circuit 222 may toggle between the video streams based on the timing information extracted by the sync stripper circuit 214.

Toggling may occur on a frame-by-frame basis to multiplex frames of video data from each of the first and second streams of video into the stream of common video data. As a result, the stream of common video data may include frames of the first stream of video data interleaved with frames of the second stream of video data. Video data includes frames that may be constructed as described in video data standards such as the NTSC standards. When there are two cameras as illustrated, each frame from one stream of video data may be preceded and followed by frames from the other stream of video data. When video data from more than two cameras is being merged, the frames may be multiplexed into the stream of common video data in a selected sequentially order that is repeated.

To form the stream of common video data the streams of video data from each of the first and second cameras 14 and 16 may be generated substantially in phase or synchronized. Frames of video data in a data stream of video data that are substantially in phase or substantially synchronized may be phase locked by a video decoder within an acceptable error tolerance and do not cause undesirable distortion or artifacts when used to produce visual images. When the streams of independently generated video data are generated in phase, the video data is frame synchronized. Thus, frames from the different streams of video data that are merged to form the stream of common video data may be processed as a single contiguous stream of video data.

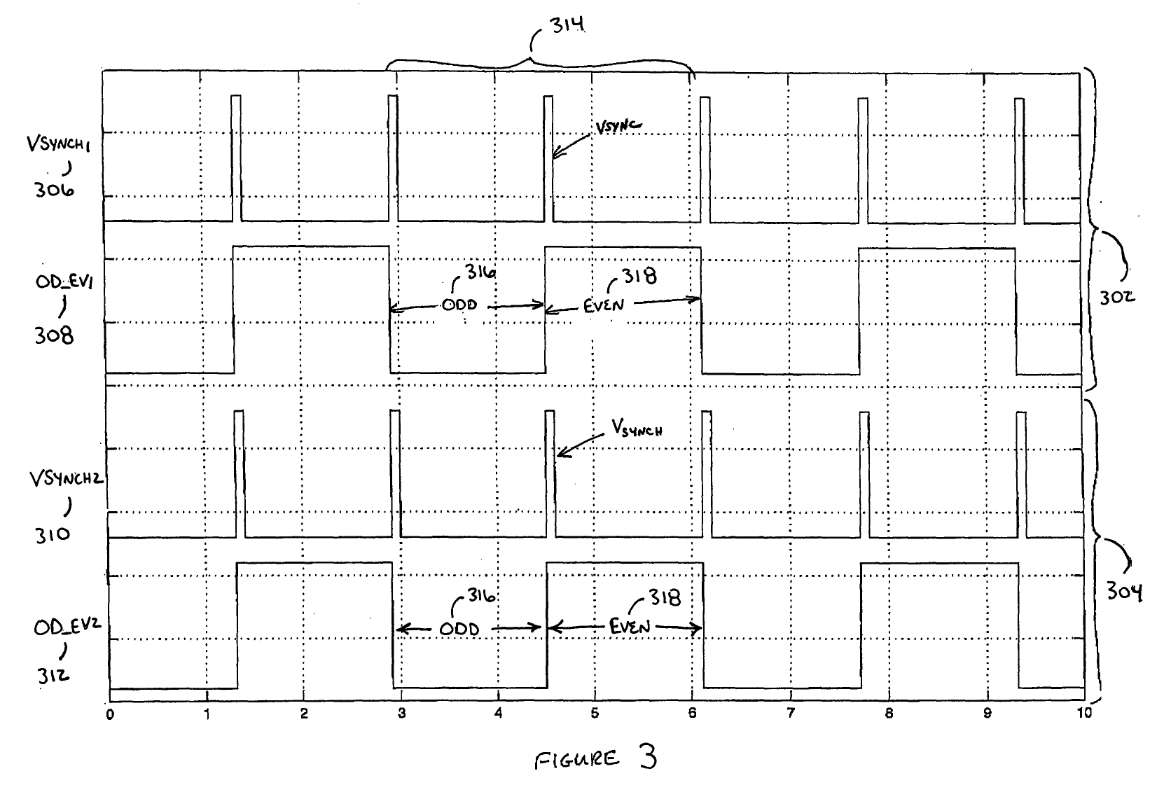

FIG. 3 is a timing diagram illustrating a first stream of timing information 302 extracted from the first stream of video data generated by the first camera 14. Also illustrated is a second stream of timing information 304 extracted from the second stream of video data generated by the second camera 16. The first stream of timing information 302 is illustrated as synchronized with the second stream of timing information 304. Accordingly, the first stream of video data is in phase (or synchronized) with the second stream of video data. The first stream of timing information 302 includes a first Vsync signal (Vsync1) 306 and a first odd/even signal (OD_EV1) 308 and the second stream of timing information 304 includes a second Vsync signal (Vsync2) 310 and a second odd/even signal (OD_EV2) 312. The first and second streams of timing information 302 and 304 each include a plurality of frames 314. Each frame 314 includes an odd field 316 and an even field 318 that form the odd/even signals 308 and 312.

Synchronization of the first and second streams of timing information 302 and 304 (and hence the video data itself) is evidenced by the continuous vertical alignment of the first and second Vsync signals 306 and 310. In addition, the even and odd fields 316 and 318 are vertically aligned. Thus, the illustrated first and second streams of timing information 302 and 304 are exactly in phase.

Referring again to FIG. 2, synchronized independent generation of video data by the first and second video cameras 14 and 16 is achievable since both cameras 14 and 16 are operating from the common clock signal generated by the camera clock 216. Phase alignment of the first and second streams of video data in a constant determined phase relationship may be performed with the hold-off circuit 218. Due to the common clock signal, the first and second video signals maintain the same phase relationship. In other words, the timing information of the substantially synchronized first and second video signals may remain in a constant relationship with respect to each other once the phase relationship of the timing information is established.

Synchronization of the independently generated video data may occur when the video surveillance system 12 is activated. The first camera 14 may be considered the reference camera. The generation of the second stream of video data from the second camera 16 may be held off with the hold-off circuit 218. The second camera 16 is held off by halting transfer of the common clock signal to the second camera 16 with the hold-off circuit 218. Generation of the second stream of video data may then be initiated in a constant phase relationship with the generation of the first stream of video data by the first camera 14 by re-enabling the transfer of the common clock signal to the second camera 16.

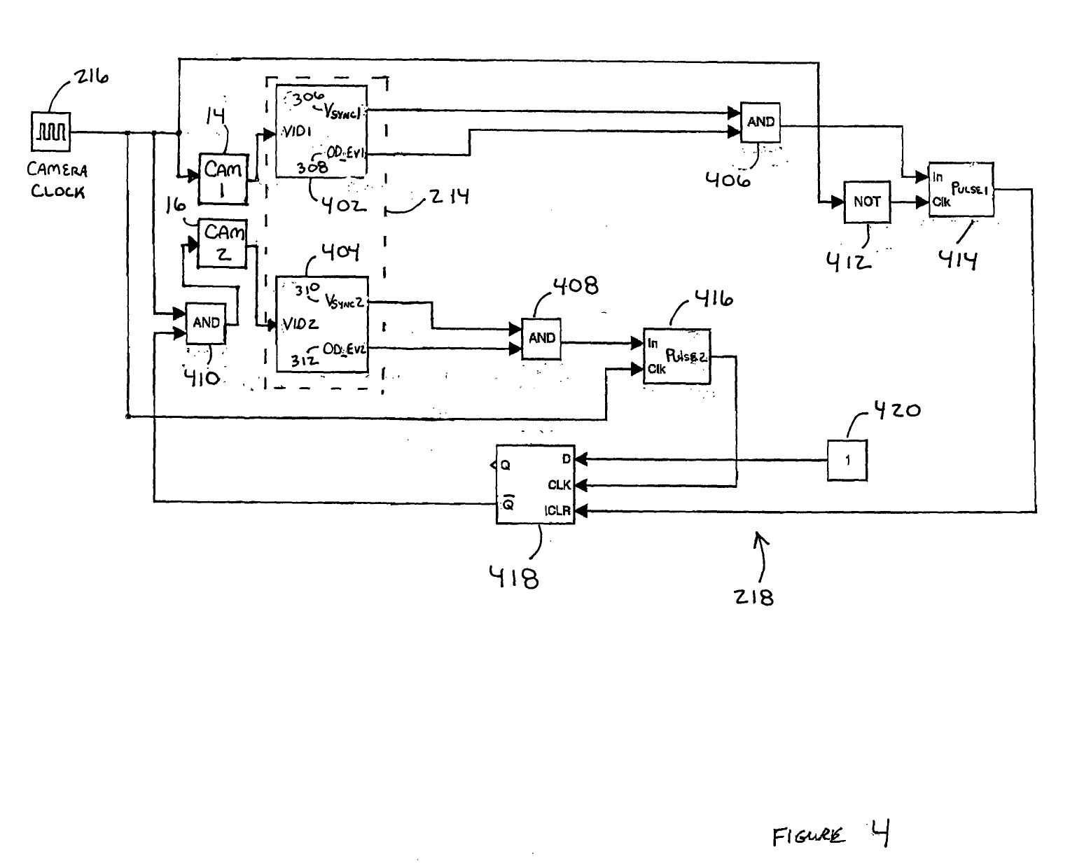

FIG. 4 is a more detailed block diagram of one example of the sync stripper circuit 214 and the hold-off circuit 218. The first and second cameras 14 and 16 and the camera clock 216 are also illustrated. As previously discussed, the first and second cameras 14 and 16 are enabled to generate video data by the common clock signal provided by the camera clock 216. The illustrated sync stripper circuit 214 includes a first sync strip circuit 402 and a second sync strip circuit 404 for each of the first and second cameras 14 and 16, respectively. An example sync strip circuit is an EL4581CS manufactured by Elantec in Milpitas, Calif. Additional sync strip circuits may be included when additional cameras are present.

When the first camera 14 is enabled by the common clock signal, the first sync strip circuit 402 may extract the first Vsync signal 306 and the first odd/even signal 308 from the first stream of video data (VID1) independently generated by the first camera 14. The second Vsync signal 310 and second odd/even signal 312 may be extracted with the second sync strip circuit 404 from the second stream of video data (VID2) that is independently generated when the second camera 16 is enabled by the common clock signal.

The first and second Vsync signals 306 and 310 and the first and second odd/even signals 308 and 312 are provided to the hold-off circuit 218. The illustrated hold-off circuit 218 includes a first AND gate 406, a second AND gate 408, a third AND gate 410, a NOT gate 412, a first one shot 414, a second one shot 416, a flip-flop 418 and a logic high constant 420. In other examples, other logical configurations may be used to achieve similar functionality.

The first Vsync signal 306 and the first odd/even signal 308 are provided to the first AND gate 406. The second Vsync signal 310 and the second odd/even signal 312 are provided to the second AND gate 408. The output of the first and second AND gates 406 and 408 are provided to the first and second one shots 414 and 416, respectively. The first one shot 414 is enabled by an inverted common clock signal provided by the NOT gate 412. The second one shot 416 is enabled directly by the common clock signal provided by the camera clock 216. A first pulse output (Pulse1) from the first one shot 414 is provided as a reset signal to the flip-flop 418. A second pulse output (Pulse2) from the second one shot 416 operates as a clock signal to set an output (Q) of the flip flop 418 with a logic high signal from the logic high constant 420. An inverted output (\overline{Q}) from the flip flop 418 and the common clock signal from the camera clock 216 is provided to the third AND gate 410. The third AND gate 410 enables the second camera 16 with the common clock signal when the inverted output (\overline{Q}) from the flip-flop 418 is reset to a logic high.

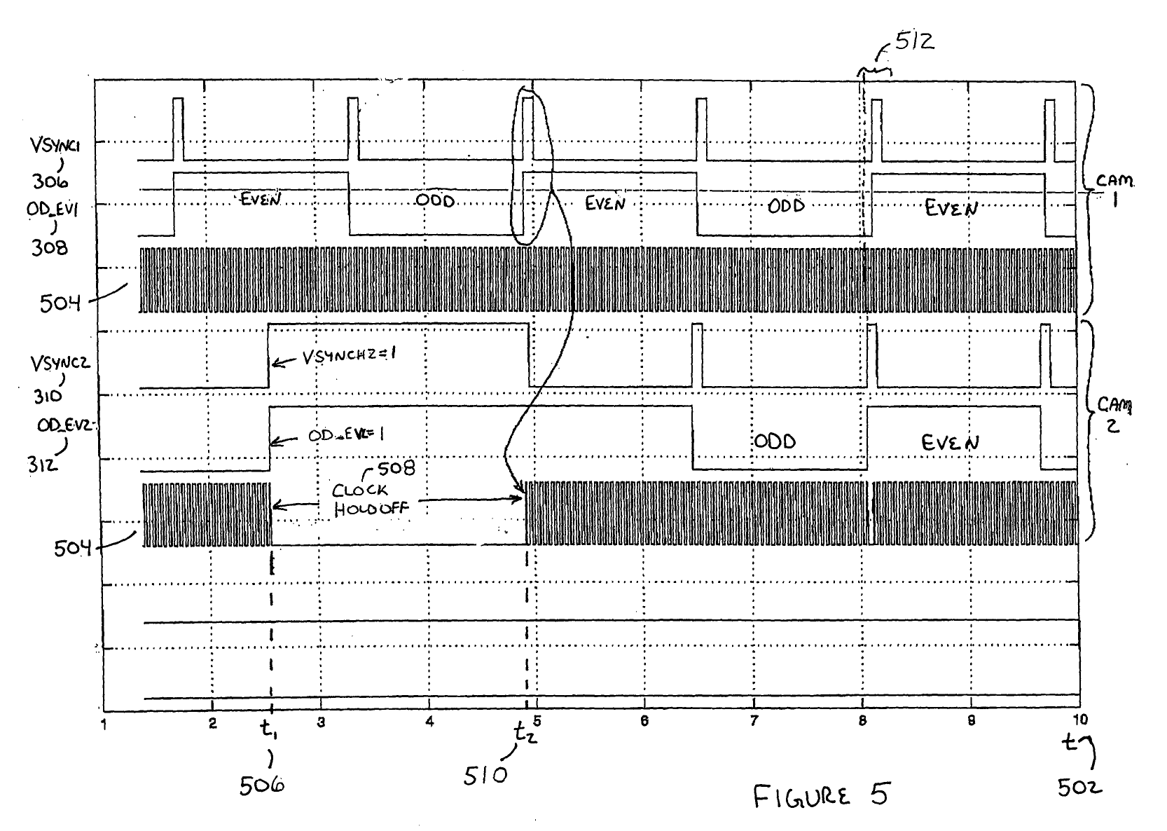

FIG. 5 is a timing diagram illustrating example operation of the first and second cameras 14 and 16, the sync stripper circuit 214, the camera clock 216 and the hold-off circuit illustrated in FIG. 4 over a period of time (t) 502. With regard to the first camera 16, the timing diagram includes the first Vsync signal 306, the first odd/even signal 308, and a common clock signal 504. The second Vsync signal 310, the second odd/even signal 312 and the common clock signal 504 with respect to the second camera 16 are also illustrated.

Referring to both FIGS. 4 and 5, during operation, the second one-shot circuit 416 fires the second pulse output (Pulse2) at time (t1) 506 when the second Vsync signal 310 and the second odd/even signal 312 are both logic high. The second pulse output (Pulse2) from the one-shot 416 clocks the flip flop 418. As a result, the flip flop 418 outputs the inverted output (\overline{Q}) as a logic low to the third AND gate 410. The third AND gate 410 disables the common clock signal from reaching the second camera 16. As illustrated in FIG. 5, the common clock signal is then provided to the first camera 14 but not the second camera 16 during a clock holdoff period 508. When the first Vsync signal 306 and the first odd/even signal 308 both become logic high, at time (t2) 510, the first one-shot 414 fires a pulse to clear the flip-flop 418. The inverted output (\overline{Q}) is provided by the flip-flop 418 as a logic high to the third AND gate 410. The third AND gate 410 thus begins providing the common clock to enable the second camera 16.

The second camera is enabled to begin generating the second stream of video data. The second stream of video data is generated substantially in phase with the first stream of video data generated by the first camera 14. Thus, the second camera 16 is directed to wait during the clock holdoff period 508 until the first stream of video data generated by the first camera 14 reaches a predetermined condition. The predetermined condition is when the first stream of video data is substantially in phase with the second stream of video data. When the first stream of video data reaches substantially the same state as the second stream of video data, a pulse is fired from the first one-shot 414 that resets the flip-flop 418 and re-enables the clocking to the second camera 16.

The second stream of video data generated by the second camera 16 is held when the second Vsync signal and the second odd/even signal are both logic high by stopping the common clock signal to the second camera 16. The second Vsync signal and the second odd/even signal may be held logic high throughout the clock hold off period 508. Once the first Vsync signal and the first odd/even signal are logic high, the second camera 16 may again be enabled by application of the common clock signal. When the second camera 16 is restarted, the waveforms of the first and second streams of video data may be substantially aligned.

The phase relationship of the first and second streams of video data may be in phase, or may have a phase offset, based on the alignment of the timing information in the first and second streams of video data. The first and second streams of video data may be substantially synchronized with a determined phase offset 512 as illustrated in the timing diagram of FIG. 5. Alternatively, the first and second streams of video data may be aligned in phase as illustrated in FIG. 3. When the first and second streams of video data are in phase, there is no phase offset. The phase relationship of the first and second streams of video data may therefore be established either in-phase or with a constant phase offset based on the timing of re-enablement of the second camera 16 by application of the common clock signal. Once the phase relationship is established by enabling the second camera 16 with the common clock signal, the phase relationship of the first and second streams of video data remain constant since the same common clock signal is enabling both the cameras 14 and 16.

The determined phase offset 512 between the first and second streams of video data is acceptable since slight phase offsets may be corrected before visible pixels are sent to a screen for display. There are several lines of video data in a video data stream that are called the vertical blanking interval (VBI). The vertical blanking interval contains both the synchronization pulses and reference color bursts for each video line. Thus, phase-lock loops of a video decoder can re-acquire lock within an acceptable error tolerance prior to painting the actual picture on the screen. If the determined phase offset 512 is too large to maintain the first and second streams of video data substantially synchronized, artifacts and other visual noise may begin to appear near the top of the screen.

Referring again to FIG. 2, the failure detection circuit 220 may be any circuit or device capable of detecting failures within the sync stripper circuit 214 and/or within either the first or second cameras 14 and 16. The failure detection circuit 220 includes at least one counter 230. The illustrated counter 230 is coupled with the sync stripper circuit 214. Csync pulses generated from each of the first and second cameras 14 and 16 may be used to reset the counter 230. If the counter 230 does not get reset for a determined amount of time, a “time-out” condition may occur and an error signal generated by the counter 230 may be detected by the microprocessor module 206.

For example, if the first and second camera each provides a stream of video data representative of a viewable display of 320×240 viewable lines, the counter 230 may be configured with a determined count that approximates a horizontal line plus a slack or tolerance. The counter 230 may be clocked from any internal clock reference. The Hsync signal from each of the cameras 14 and 16 indicates the start of a video line. If the counter 230 overflows (e.g. the count is greater than the determined time plus slack), an error signal is generated.

The counter 230 may also be disabled during startup when generation of the second stream of video data is being synchronized with the first stream of video data. In addition, the error signal generated by the counter 230 may be reset a determined number of times (de-bounced) to avoid falsely reporting an error condition. The error signal output from the counter 230 may be provided to the control module 206 that is discussed later.

The video data merger circuit 222 may be any circuit or device capable of merging the first stream of video data from the first camera 14, and the second stream of video data from the second camera 16 to form a contiguous stream of common video data as an output. In the illustrated example, the video data merger circuit 222 receives analog streams of video data from both the first camera 14 and the second camera 16 and outputs a single contiguous analog stream of video data. Since the two streams of video data are generated substantially synchronized, the video data merger circuit 222 may select between the streams of video data to form the contiguous stream of common video data. Selection may be performed on a frame-by-frame basis to interleave the frames from each of the streams of video data. Alternatively, selection may be performed based on some other criteria such as a plurality of frames, a time period or any other mechanism for interleaving the streams of video data.

The video data merger circuit 222 may also be coupled with the sync stripper circuit 214 to receive the timing information. The timing information may be used to toggle between the streams of video data. For example, the video data merger circuit 222 may be an analog multiplexer such as a MAX4310 video mux by Maxim, Inc. of Sunnyvale, Calif. The analog multiplexer may be toggled on a frame-by-frame basis by toggling when both the second Vsync signal 310 and the second odd/even signal 312 (FIGS. 3 and 5) reach a logic high state. Thus, frames from both the first and second streams of video data are sequentially arranged to form a contiguous stream of video data that is the stream of common video data. In addition, the single contiguous stream of common video data may be provided to the video processing module 204.

The video processing module 204 includes a decoder circuit 236, a processing clock 238 a compressor circuit 240 and a watchdog timer 242. The stream of common video data provided by the video data merger circuit 222 may be received and processed with the decoder circuit 236. The processing clock 238 may provide a pixel clock signal with a frequency, such as about 24.576 MHz, to the decoder circuit 236.

The decoder circuit 236 may be any circuit or device capable of demodulating the single stream of common video data into component video data referred to as “YUV” component video data. An example decoder circuit 236 is an SAA7111 color decoder manufactured by Philips Semiconductor of Sunnyvale, Calif. Within the “YUV” component video data, the “Y” refers to a brightness (or luminance) component, the “U” refers to a first color (or chrominance) component and the “V” refers to a second color (or chrominance) component. The decoder circuit 236 may provide the YUV component video data as a digital signal at a determined frequency, such as 13.5 MHz. The digital signal may be provided to the compressor circuit 240.

The compressor circuit 240 may be any circuit or device capable of minimizing the size and therefore the storage requirements of the YUV component video data provided from the decoder circuit 236. An example compressor circuit is a ZR36060-27 MJPEG Video Compressor by Zoran of Sunnyvale, Calif. The format of the YUV video components provided by the decoder circuit 236 may be compatible with the compressor circuit 240. For example, the ZR36060-27 compressor circuit only recognizes the YUV 4:2:2 format so the decoder circuit 236 may be configured to output this format. The compressor circuit 240 also receives the pixel clock signal to maintain synchronization with the decoder circuit 236. For example, double the pixel clock signal may be provided to the compressor circuit 240.

The compressed video component data may be output by the compressor circuit 240 at a determined frequency. The determined frequency may be based on the amount of compression desired. For example, the compressed video component data may be generated at a frequency of 1.2 MHz.

The watchdog timer 242 may also be included in the video processing module 204. The watchdog timer 242 may provide a failure detection mechanism for both the decoder circuit 236 and the compressor circuit 240. Activity from the decoder circuit 236 and the compressor circuit 240 may be monitored with the watchdog timer 242. An error signal may be triggered when activity is not detected within a determined period of time. The error signal may be reset a number of times before an alarm is sounded to avoid false positives. Alternatively, where this additional error checking is not desired, the watchdog timer 242 may be omitted. The control module 206 may monitor the watchdog timer 242.

The control module 206 may be any circuit or device(s) that controls the overall operation of the video surveillance system 12 (FIG. 1). The illustrated control circuit 206 includes a memory 250, a processor 252 and an annunciator 254. In other examples, the control circuit 206 may have additional or fewer components to provide the functionality described.

The memory 250 may be one or more solid-state memory storage device(s) accessible by the processor 252, such as a random access memory (RAM), FLASH memory, electrically erasable programmable read-only memory (EEPROM), etc. The memory 250 may include non-volatile memory, volatile memory with battery back up or some combination of volatile and non-volatile memory.

The compressed video data may be stored in the memory 250. In addition, other data related to the video surveillance system 12 such as alarms, indications, input signals, etc. may be stored in the memory 250. As discussed later, instructions executed by the processor 252 may also be stored in the memory 250. Data and instructions stored in the memory 250 may be accessed, modified, etc.

The memory 250 may also include a portable memory device 258, such as a FLASH memory card that is capable of being detachably coupled with the video controller unit 18. The portable memory device 258 may also be detachably coupled with an external computing device via, for example, a flash memory card reader. When coupled with the video controller unit 18, the portable memory device 258 may be used to store the common stream of compressed video data. In addition, other data related to the surveillance system as well as instructions executable by the processor 252 may be stored in the portable memory device 258.

For example, the compressed video data may be stored directly in the portable memory device 258 by the processor 252. In another example, the memory 250 may include volatile RAM in cooperative operation with the portable memory device 258. In this example, the volatile RAM may provide compressed video data storage during operation. Accordingly, a continuous loop of compressed video data may be stored in volatile RAM until operation is stopped. When operation is stopped, the video data in the volatile RAM may be dumped to the portable memory device 258. The portable memory device 258 may then be removed and coupled with an external computing device for analysis of the data.

The processor 252 may be any computing device capable of processing digital inputs and digital outputs, such as a digital signal processor (DSP). More specifically, the processor 252 may be capable of receiving and directing the storage of compressed video data from the compressor circuit 240 in the memory 250. The example processor 252 includes a buffer 262, a microcontroller 264 and a control clock 266.

The buffer 262 may be a first in-first out (FIFO) buffer capable of buffering the compressed video data supplied from the compressor circuit 240 prior to storage in the memory 250. As previously discussed, the compressed video data may be stored in the memory 250 in a portable memory device 258, such as a FLASH memory card. The buffer 262 may be configured with the capability to queue enough compressed video data samples to allow for the long wait states that may occur when writing data to FLASH memory. For example, the buffer 262 may be sized to handle a worst-case FLASH card's BUSY signal. In this way, a user may select any available Compact Flash™ card on the market for use in the video surveillance system 12 (FIG. 1).

The microcontroller 264 may be any logic-based circuit or device capable of executing instructions to control operation of the video surveillance system 12 (FIG. 1), such as a Z8F6403 microcontroller manufactured by Zilog of San Jose, Calif. Instructions executed by the microcontroller 264 may be stored in the memory 250 as previously discussed. In addition, the microcontroller 264 may sense digital and/or analog inputs and generate digital and/or analog outputs. Instructions may be executed by the microcontroller 264 in response to sensed input signals. Output signals may also be initiated by the microcontroller 264 based on executed instructions.

Control of the transfer of compressed video data from the buffer 262 to the memory 250 may also be based on instruction executed by the microcontroller 264. Instructions in the microcontroller 264 may also control the number of frames stored per second in the memory 250. The microcontroller 264 may sense an input such as a selector switch to set the frames-per-second storage rate. The microcontroller 264 may also execute instructions to perform diagnostic testing and continuously monitor for failure indication from other circuits in the video surveillance system 12.

Diagnostics may be performed at power up of the microcontroller 264. Alternatively, diagnostics may be performed during powerup and/or during operation of the microcontroller 264. During diagnostics, the microcontroller 264 may perform self-diagnostics. Once self-diagnostics are completed, the microcontroller 264 may gather informational data related to the memory 250 such as the memory capacity, manufacturer, etc. In addition, the microcontroller 264 may gather information on the portable memory device 258, and may also format the portable memory device 258, if necessary. The microcontroller 264 may also write and read back a checkerboard and inverse checkerboard pattern from the memory 250 or any other such algorithms to verify the integrity of the memory 250.

After the memory 250 has been verified the microcontroller 264 may reset the watchdog timer 242 and wait for a prescribed amount of time (depending on the time it takes for the cycle of the watchdog timer to complete) to check the flag again. If the flag is set, the microcontroller 264 may reset the flag again and wait. This process will continue for a determined number of successive checks, such as eight, before activating the annunciator 254. If the flag gets reset and stays reset, the microcontroller 264 may exit the check loop. After all diagnostics have been completed, the microcontroller 264 may provide indication that the system is fully functional and has begun to collect video data. Failure of the microcontroller 264 and/or other portions of the video surveillance system 12 may be indicated with the annunciator 254.

The annunciator 254 may be any circuit(s) or device(s) that provide visual and/or audible indication relating to the video surveillance system 12. (FIG. 1) In the illustrated example, the annunciator 254 includes a speaker 268 for audible alarms and at least one indicator 270 for visual alarms. Alternatively, the annunciator 254 may include any other form of user interface providing indication of conditions within the video surveillance system 12. In addition, the annunciator 254 may be wirelessly or wireline coupled with a vehicle bus and/or a remote monitoring device to provide annunciation on a remote user interface.

The speaker 268 may be any device capable of emitting audible sound in response to an electrical signal, such as a piezo. The speaker 268 may be driven by the microcontroller 264 to produce audible sounds. For example, during startup, an audible sound that is a 2400 Hz tone indicating that the system is completely operational based on system diagnostic checks and has begun recording the stream of common video data may be initiated by the microcontroller 264.

The indicators 270 may be one or more LEDs, or any other device capable of visual changes in response to electrical signals. When the indicators 270 are LEDs, the LEDs may blink or remain on continuously to provide indication. The indicators 270 may provide indication related to any aspect of the video surveillance system 12. For example, when the video surveillance system 12 is installed in a vehicle, separate indicators may be activated to indicate failure conditions or external events such as:

1. System failure;

2. Camera failure;

3. Memory failure; and

4. External event detected.

In other examples, the indicators 270 may provide any other indications, or combinations of indications. In addition, the speaker 268 and the indicator(s) 270 may be used in combination to provide indications. For example, any diagnostic error identified by the microcontroller 264 may result in activation of one or more of its corresponding indicators and an audio signal such as a tone chirp (250 mS tone duration) every 10 seconds until the condition causing the diagnostic error is corrected.

The indicators 270 may also provide indication of system maintenance. For example, during the time that new instructions, such as a revised/new operating system, are being loaded into the memory 250, multiple indicators 270 may be activated in succession. Once the new instructions are loaded, the indicators 270 may remain illuminated until the video surveillance system 12 is powered down.

The external indication module 208 may be any circuit(s) and/or device(s) capable of providing a signal(s) indicative of an external event to the control module 206. In the example of FIG. 2, the illustrated external indication circuit 208 includes a shock sensor 272 for use in an example vehicle application. Depending on the application, any other external event may be detected and provided to the video surveillance system. For example in a convenience store application, the external event may be a contact closure indicative of an alarm button, an open safe door, etc.

The shock sensor 272 may be a sensing device capable of detecting an impact to the vehicle 10, such as a collision. The force of the collision may be converted to a voltage, such as mV/G by the shock sensor 272. The shock sensor 272 may detect forces in the X and Y directions since a vehicle 10 may be hit from the front, back or sides. Upon detection of a force above a determined threshold, the shock sensor 272 may be activated to provide a shock signal indicating the force has been experienced. The shock signal may be a binary signal or an analog signal. The shock sensor 272 may be an electrical accelerometer such as an ADXL250 manufactured by Analog Devices of Norwood, Mass. Alternatively the shock sensor 272 may be an electromechanical device.

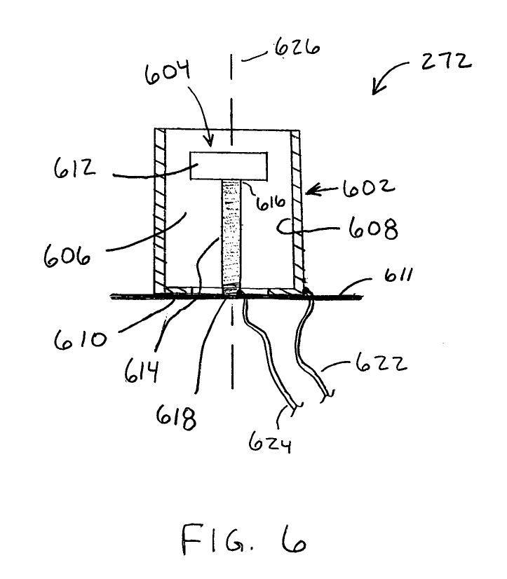

FIG. 6 is a cutaway side view of an example shock sensor 272. The shock sensor 272 includes a housing 602 and a detector 604 disposed within the housing 602. The housing 602 may be cylindrically shaped metal or some other conductive material that is formed with a cavity 606 in which the detector 604 is disposed. The housing 602 includes a longitudinally extending inner wall 608 positioned adjacent the detector 604. In addition, the housing 602 includes a lower lip 610 that extends from the inner wall 608 towards the detector 604. The housing 602 is coupled to a mounting surface 611, such as a circuit board, adjacent the lower lip 610.

The detector 604 includes a detector head 612 conductively coupled with a flexible detector body 614 at a first end 616 of the detector body 614. The detector body 614 may be fixedly coupled with the mounting surface 611 at a second end 618. The detector head 612 and the detector body 614 may be formed of a rigid conductive material. The detector body 614 may be flexible, but with sufficient rigidity to maintain the detector head 612 away from the inner wall 608 of the housing 602. The shock sensor 272 also includes a first conductor 622 coupled with the housing 602 and a second conductor 624 coupled with the detector body 614.

During operation, the detector head 612 may be maintained substantially concentric with a central axis 626 of the housing 602. When the shock sensor 272 is subject to a force in the X-Y plane, the detector body 614 allows the detector head 612 to move toward the inner wall 608 in response to the force. When the force is above a determined threshold, the detector head 612 may move enough to contact the inner wall 608. Contact between the inner wall 608 and the detector head 612 may provide a signal indicative of the contact on the first and second conductors 622 and 624.

For example, the detector head 612 may be energized with a magnitude of voltage provided on the second conductor 624. When the detector head 612 contacts the inner wall 608, the inner wall 608 and the first conductor 622 may be energized with the magnitude of voltage. The shock sensor 272 may also include an adjustment of the magnitude of voltage such as a digital potentiometer that may be tuned by the microcontroller 264 (FIG. 2). Alternatively, an analog potentiometer may be used to adjust the magnitude of voltage.

Referring again to FIG. 2, the microcontroller 264 may detect the force signal indicating that the shock sensor 274 has experienced a force above the determined threshold. In response to the force signal, the microcontroller 264 may enter a collision mode and perform as previously described to save the collected video data and indicate a vehicle 10 (FIG. 1) has been involved in a collision. The microcontroller 264 may be maintained in the collision mode until manually reset.

The power conditioning module 210 may be any circuit(s) or device(s) capable of providing regulated determined voltages for a determined time following loss of source power. The illustrated example power conditioning circuit 210 includes a connector 280, a converter 282, a low voltage detector 284 and a power indicator 286. In other examples, fewer or additional components may be illustrated to depict the functionality of the power conditioning module 210.

The connector 280 may be any form of connection to a power supply. In a vehicle 10, the connector 280 may be a male cigarette lighter plug that is connectable with a cigarette lighter socket to obtain accessory power from a vehicle. The connector 280 may also include overcurrent protection, such as a fuse and surge protection circuitry to minimize transients. The converter 282 may be any form of voltage converter capable of converting the source power to at least one output voltage compatible with the video surveillance system 12. In a vehicle, the converter 282 may be a DC to DC converter to supply regulated DC voltages of proper magnitude for the cameras 14 and 16 and the video controller 18 (FIG. 1). The converter 282 may also be configured with an energy storage device 288, such as a capacitor or a battery to continue to supply power to the video surveillance system 12 for a determined period of time following a loss of source power.

The low voltage detector 284 may be any circuit or device capable of detecting a determined low voltage condition of the supply voltage provided to the converter 282. The low voltage detector 284 may provide a signal, such as a contact closure, to the microcontroller 264 indicative of the occurrence of a low supply voltage condition. Alternatively, the microcontroller 264 may perform low voltage detection using an analog-to-digital (A/D) converter in place of the low voltage detector 284.

Upon receipt of the low supply voltage indication from the low voltage detector 284, the microcontroller 264 may commence an orderly shutdown of the video surveillance system 12. Accordingly, upon an abrupt loss of supply voltage to the converter 282, the converter 282 may continue to supply output voltage to the video surveillance system 12 from the energy storage device 288 that is above the low supply voltage. As the energy storage device 288 is depleted, the low voltage detector 284 may provide indication to the microcontroller 264 of the low supply voltage condition and the video surveillance system 12 may be shut down in an orderly fashion without loss of significant video data.

Referring now to FIGS. 1 and 2, and the example application of the video surveillance system 12 to a vehicle 10, the video surveillance system 12 may be activated whenever the vehicle 10 is turned on. In addition, the video surveillance system may be automatically activated in response to an external event, such as a collision, that occurs while the vehicle 10 is turned off. For example, an unattended vehicle 10 may be involved in a collision while parked in a parking lot. If the video surveillance system 12 is activated in response to an external event, video data may be captured for a determined period of time, and the video surveillance system 12 may then deactivate thereby storing the video data surrounding the external event.

As such, when the ignition of the vehicle 10 is enabled or a collision detected while disabled, power may be supplied to the video surveillance system 12. When activated, the sync and frame merge module 202 may substantially synchronize the generation of the analog stream of video data from the second camera 16 with the analog stream of video data generated by the first camera 14. The two streams of video data may be merged by the sync and frame merge module 202 to form the common analog stream of video data. The stream of common video data may be decoded to form digital data and compressed by the video processing circuit 204. The compressed digital video data may be buffered by the buffer 262.

The microcontroller 264 may direct the continuous storage of the compressed digital video data representative of the stream of common video data while the vehicle is operating. The stream of common video data may be continuously stored in a loop within the memory 250 in a single data file such that the oldest compressed video data is constantly being overwritten by the newest compressed video data. Accordingly, at any given time during operation of the vehicle 10, compressed video data from a determined period of time, such as the previous 5 or 10 minutes, may be stored in the memory 250.

The oldest compressed video data is overwritten at the direction of the microcontroller 264. The microcontroller 264 is provided with the size of the memory 250 available for storage of the compressed video data. Alternatively, the microcontroller 264 may determine the size of the memory 250. The microcontroller 264 may also determine the recording loop time associated with storing video data in the memory 250 in a continuous loop. Compressed video data may then be stored until the available size is reached and the microcontroller 264 then starts over. For example, when the video data is stored in the portable memory device 258 that is a FLASH memory, the FLASH memory includes a plurality of sectors of 256 bytes each. The microcontroller 264 may write compressed video data in increments of 256 bytes until all the sectors are filled. The microcontroller 264 may then return to the first sector and begin writing new compressed digital video data into the sectors.

The continuous storage of video data may be interrupted by an external event sensed by the external indication module 208, such as a sensed impact on the vehicle 10, a breaking window, erratic driving behavior, etc. For example, the microcontroller 264 may receive an input from the shock latch 274. Alternatively, the continuous storage of video data may be manually interrupted such as, for example, by something as simple as an on/off switch mounted to the dashboard of the vehicle 10 or disconnection of the connector 280 from the power source.

Accordingly, the video surveillance system 12 may be configured for automatic shut off after a determined period of time under conditions where the driver wants to retain recently stored video data. For example, when the vehicle 10 is directly involved in a collision the video surveillance system 12 may be configured for auto shutoff. Similarly, when the driver wishes to preserve evidence of an incident witnessed while in the vehicle 10, such as a collision between other vehicles the system may be manually shutoff by disconnection of the source power.

If, for example, the video surveillance system 12 is installed in a vehicle 10, and a collision is detected, the speaker 268 may be driven by the microcontroller 264 to produce a 2-second 2400 Hz tone and then chirp once per second for 60 seconds. After the 60 second period, the microcontroller 264 may direct the video surveillance system 12 to stop recording and an indicator 270 indicative of “collision detected” may be activated by the microcontroller 264. Power may be removed from the video surveillance system 12 and the portable memory device 258 may then be removed and analyzed. Power may be restored to the video surveillance system 12 to reset the microcontroller 264 and once again begin the process of capturing video data in the memory 250.

As previously discussed, the video data from at least two video cameras 14 and 16 may be efficiently processed and then stored as a single data file to minimize processing complexity and memory consumption. Efficient processing of the video data may involve synchronized streams of video data from each of the cameras 14 and 16. The independently generated streams of video data may be interleaved, decoded and then compressed to form a single video data file in the memory 250. By synchronizing the independent generation of the streams of video data from the cameras 14 and 16 with the video merging module 202, video data from both of the cameras 14 and 16 may be efficiently sampled, compressed and stored. Efficient sampling, compression and storage may be achieved by sequentially processing video data from each of the cameras 14 and 16 to avoid separately storing the video data from each of the cameras 14 and 16. Separate processing and storage is avoided by merging the video data from each of the cameras 14 and 16 to create a single video data file capable of being stored.

The stored single video data file may be retrieved from the memory 250 by coupling an external computing device such as the laptop computer 32 via the interface link 34 (FIG. 1). Alternatively, the portable memory device 258 may be detached from the video controller unit 18 and detachably coupled with an external computing device to retrieve the stored single video data file. Once retrieved, the single video data file may be decompressed and de-interleaved to separate the streams of video data from the each of the cameras 14 and 16. Alternatively, as part of the process of retrieving the video data from memory 250, the microcontroller 264 may decompress and de-interleave the video data prior to transfer to the laptop computer 32.

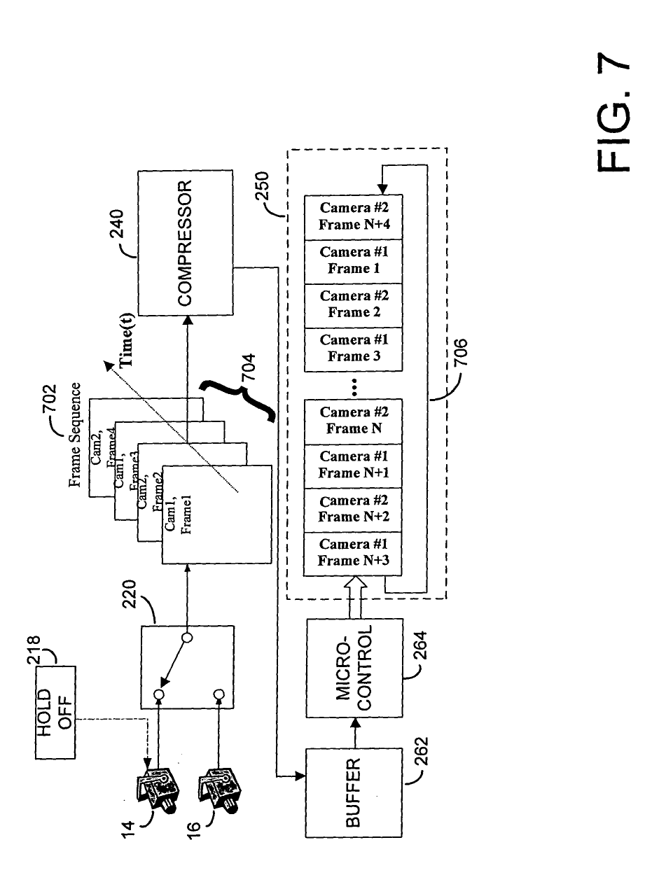

FIG. 7 is a process flow diagram illustrating the operation of the video surveillance system 12 discussed with reference to FIGS. 1-6. When the video surveillance system 12 is energized, the hold off circuit 218 may substantially synchronize the independent generation of the second stream of video data from the second camera 16 to the first stream of video data independently generated with the first camera 14. Once independent generation of the streams of video data are substantially synchronized, the video data merger circuit 222 may merge the video data to form a stream of common video data. The video data merger circuit 222 may create the stream of common video data as one contiguous stream of video data. The stream of common video data may be formed by switching between receiving a stream of video data from the first camera 14 and receiving a stream of video data from the second camera 16. Switching may be based on, for example, a frame time which is the period of time represented in each frame.

In the illustrated example, the video data merger circuit 222 may switch between the cameras 14 and 16 to provide alternating frames. As used herein, the term “frame” or “frames” refers to a segment of video data that is identified by timing information embedded in the stream of video data generated by each of the cameras 14 or 16. The video data merger circuit 222 may select between the first and second streams of video data on a frame-by-frame basis. Thus, the switching frequency of the video data merger circuit 222 may be based on the size of the frames of video data generated by the cameras 14 and 16. The period of time in which video data is lost from the currently unselected camera is also based on the size of each of the frames. The amount of video data in each frame may be based on the frame resolution. Frame resolution may involve the resolution of the cameras 14 and 16 as well as the sampling period of the decoder circuit 236 (FIG. 2).

As illustrated in FIG. 7, synchronization of streams of video data from each of the first and second cameras 14 and 16 results in a frame sequence 702 in which frames 704 from each of the cameras 14 and 16 are sequentially provided to the video processing module 204 over a period of time (t). The interleaved configuration of the frames 704 is illustrated as alternating between frames 704 from the first camera 14 and frames 704 from the second camera 16 to provide a sequence (illustrated in FIG. 7 as frames 1-4) to the video processing module 204 (FIG. 2).

The frames 704 may be compressed by the compressor circuit 240. As previously discussed, the compressor circuit 240 may use a compression algorithm such as intra-frame compression or inter-frame compression. Intra-frame compression may involve wavelet transformation or Motion-JPEG (MJPEG). Intra-frame compression may be performed on individual frames and therefore does NOT depend on prior or subsequent frames 704 to compress the video data of the current frame 704.

Inter-frame compression algorithms such as MPEG-1 and MPEG-2 may compress multiple frames together as a group. With intra-frame compression, the prior and subsequent frames 704 in the sequence may be from a different video source (either camera 14 or 16). With inter-frame compression, on the other hand, the frames 704 from each of the cameras 14 and 16 may be buffered separately and then compressed in groups. The compressed groups of frames from each of the first and second cameras 14 and 16 may then be interleaved to form a single contiguous stream of common video data. It should be noted that the intra-frame compression is probably the least complex and most cost effective.

Following compression, the compressed frames 704 of video data may be temporarily stored in the buffer 262. The micro-controller 264 may sequentially move the compressed frames from the buffer 262 to the memory 250. The micro-controller 264 may direct the storage of the compressed frames of video data in the memory 250.

The frames 704 may be stored in the memory 250 as part of a continuous loop of video data as illustrated by arrow 706. The continuous loop of data may be stored in the memory 250 as a single data file that includes interleaved video data from both the first and second cameras 14 and 16. Accordingly, the process of sampling, compressing and storing video data from multiple cameras may be performed efficiently and cost effectively with minimized complexity.

In another example, the first and second cameras 14 and 16 may be capable of generating respective first and second streams of video data in digital form. For example, the first and second cameras 14 and 16 may include MJPEG encoders, MPEG-1 encoders, MPEG-2 encoders or any other type of digital encoder. The digital encoders may also provide compression capability within each of the first and second cameras 14 and 16 to compress the respective streams of digital video data.

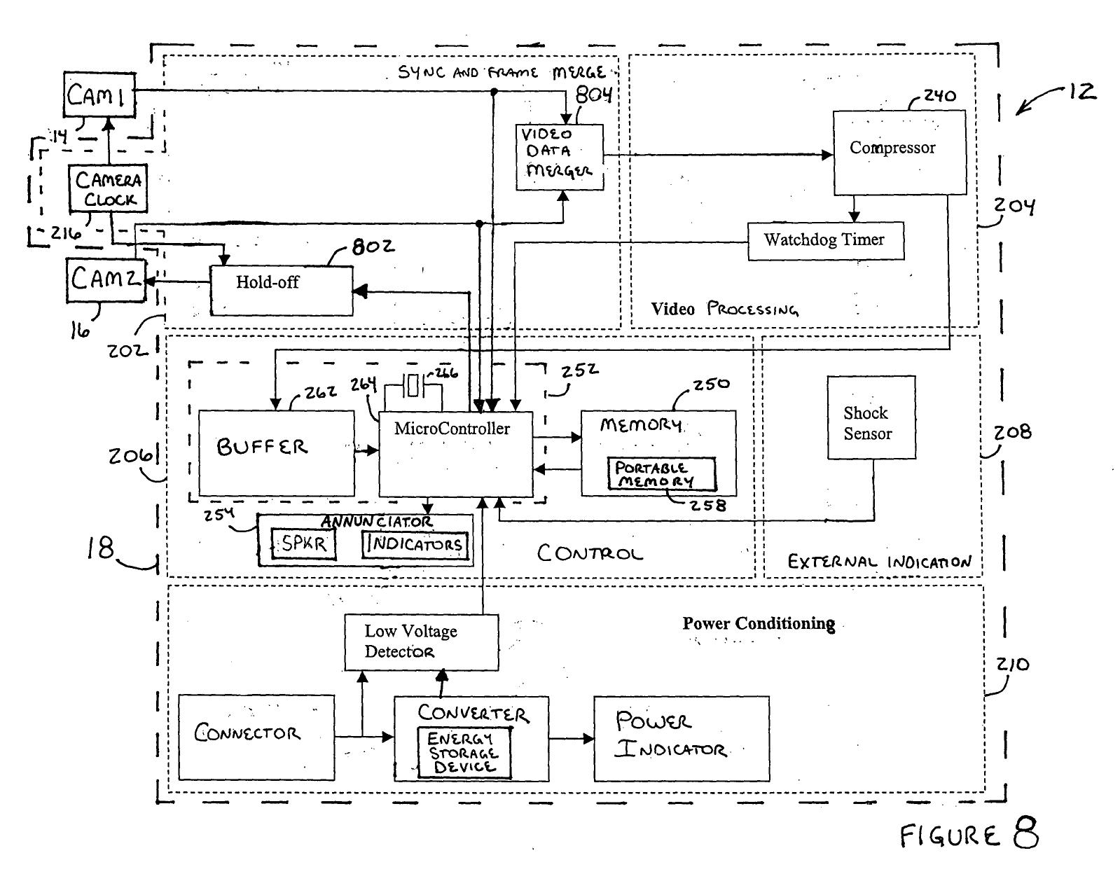

FIG. 8 is a block diagram of another example video surveillance system 12 that includes first and second cameras 12 and 14 that generate respective first and second streams of video data in digital form. As in the previous examples, the video surveillance system 12 includes the video merging module 202, the control module 206, the external indication module 208 and the power conditioning module 210. In addition, the video surveillance system 12 may include the processing module 204.

In this example, the sync and frame merge module 202 includes the camera clock 216, a hold-off circuit 802 and a video data merger circuit 804. The control module 204 may include the memory 250, the processor 252 and the annunciator 254. The processor 252 includes the buffer 262, the microcontroller 264 and the control clock 266. The memory 250 may include the portable memory device 258. Some of the functionality within the circuits is different due to the streams of video data being generated in digital form. For purposes of brevity, the remaining discussion will focus primarily on differences with the previous examples.

Since the cameras 14 and 16 generate digital data, the microcontroller 264 may direct the synchronized independent generation of the streams of digital data. Similar to the previous example, the first camera 14 may be the reference camera. Since the streams of video data are in digital form, the streams may each be provided directly to the microcontroller 234. The microcontroller 264 may execute instructions to perform frame marker stripping and monitor for a frame marker embedded in the first stream of digital video data from the first camera 14. In addition, the microcontroller 234 may execute instructions to perform frame marker stripping and monitor for a frame marker embedded in the second stream of digital video data generated by the second camera 16. The frame markers may indicate timing information.

Upon identification of the frame marker in the second stream of digital video data, the hold off circuit 802 may be activated by the microcontroller 264 to disable the common clock signal from enabling the second camera 16. The microcontroller 264 may then monitor for a similar frame marker in the first stream of digital video data. Upon identification of the frame marker in the first stream of digital video data, the microcontroller 264 may deactivate the hold-off circuit 802 and enable the second camera 16 with the common clock signal. The second stream of digital video data may thus be generated substantially in phase with the first stream of digital video data.

The substantially synchronized, but independently generated, first and second streams of digital video data may be merged by the video data merger circuit 804. Frames of video data from each of the first and second cameras 14 and 16 may be interleaved on a frame-by-frame basis, or in determined blocks as previously discussed. As a result, a contiguous common stream of digital video data is provided by the video data merger circuit 804.

If the first and second cameras 14 and 16 include compression capability, the video processing module 204 may be omitted. Otherwise, the video processing module 204 may receive the common stream of digital video data. The common stream of digital video data may be provided to the compressor circuit 240 included in the video processing module 204. The stream of common video data may be compressed and provided to the control module 206. Alternatively, when the video processing module 204 is omitted, the common stream of digital video data may be provided directly to the control module 206. The control module 206 may buffer and store the common stream of compressed digital video data in the memory 250 as previously discussed.

Referring to FIGS. 1, 2 and 8, following storage of the video data in the memory 250, the video data may be extracted, de-interleaved, decompressed and viewed. For example, the video data may be stored in the portable memory device 258. The portable memory device 258 may be detached from the video surveillance system 12 and coupled with a computing device (not shown) operating a video file converter application. The computing device may be any type of computer, such as a personal computer, that includes a display, a user interface, a processor, data storage, etc. In addition, the computing device may include an interface to couple with the portable memory device 258.

The video file converter application may generate a console window on the display of the computing device. The console window may include a menu, such as a pull down menu, accessible with the user interface to direct operation of the video file converter application. Using the menu, the video file converter application may be directed to download the video data from the memory 250.

The video file converter application may then be used to search the stored compressed video data to identify sequence codes. In addition, the video file converter application may decompress and split the interleaved stream of common video data back into separate streams of video data for each of the first and second cameras 14 and 16. Alternatively, the interleaved common stream of video data may be de-interleaved and then decompressed.

During processing of the video data, the video file converter application may also determine the beginning and end of the stream of common video data. As previously discussed, the stream of common video data is stored in a continuous loop. During the storage process, sequence codes may be added to the stream of common video data at one or more fixed locations. Based on the sequence codes, the video file converter application may determine the beginning and end of the video data. Alternatively, time stamps, sequential counters or any other mechanism indicative of the beginning and end of the continuous loop of common video data may be used.

The previously discussed video surveillance system provides a simple, cost effective system capable of capturing the occurrence of actual events. Utilizing streams of video data that are independently generated by multiple cameras, various different views of one or more areas may be captured. The streams of video data may be generated substantially in synchronism by the cameras. The synchronized video data may then be merged to form a single stream of common video data representative of multiple independent streams of video data. The stream of common video data may be efficiently stored in a continuous loop of a predetermined duration. The video data may be stored in a memory such as a portable memory device.

Upon the occurrence of an external event, the video surveillance system may continue capturing and storing video data for a determined period of time and then turn off. The portable memory device may be detached from the video surveillance system. The video data may then be downloaded from the portable memory device, and the individual streams of video data may be extracted from the stream of common video data. The individual streams of video data may be viewed to review the events surrounding the external event.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A video surveillance system comprising:
at least two video cameras each configured to independently generate video data; and
a video controller coupled with the video cameras, wherein the video controller is configured to substantially synchronize and then merge the video data generated by each of the video cameras to form a single contiguous stream of common video data,
the single contiguous stream of common video data storable in a data file.

2. The video surveillance system of claim 1, wherein the video controller is configured to direct the video cameras to independently generate video data that is generated substantially in phase with a phase relationship that remains constant.

3. The video surveillance system of claim 1, further comprising a camera clock configured to generate a common clock signal, wherein the video cameras are enabled to generate video data with the same common clock signal.

4. The video surveillance system of claim 1, wherein the single contiguous stream of common video data is storable by the video controller in a continuous loop such that the oldest video data is overwritten by the newest video data.

5. The video surveillance system of claim 1, wherein the single contiguous stream of common video data comprises a plurality of frames of video data from each of the video cameras that alternate between each of the video cameras on a frame-by-frame basis.

6. The video surveillance system of claim 1, wherein the video controller is configured to interleave frames of video data from each of the video cameras to form the single contiguous stream of common video data.

7. A video surveillance system comprising:
at least two video cameras each configured to independently generate video data; and
a video controller coupled with the video cameras, wherein the video controller is configured to direct substantially synchronized generation of the video data in a constant phase relationship by each of the video cameras,
the video controller further configured to merge the video data generated by each of the video cameras to form a single contiguous stream of common video data,
the single contiguous stream of common video data storable in a data file.

8. The video surveillance system of claim 7, wherein the single contiguous stream of common video data is representative of the video data generated by each of the video cameras.

9. The video surveillance system of claim 7, wherein the video cameras and the video controller are configured to be mounted in a vehicle.

10. The video surveillance system of claim 9, wherein the video controller comprises a shock sensor, the shock sensor configured to detect forces associated with a collision of the vehicle and provide indication to the video controller.

11. The video surveillance system of claim 10, wherein the video controller is configured to continue capturing video data from the first and second cameras for a determined time following indication of a collision by the shock sensor.

12. The video surveillance system of claim 10, wherein the shock sensor comprises a detector and a housing, wherein the detector is disposed within the housing without contacting the housing, the indication to the video controller is in response to a force that causes contact between the housing and the detector.

13. The video surveillance system of claim 7, wherein the video controller comprises a portable memory device that is detachable from the video controller, the single contiguous stream of common video data storable in the portable memory device as the data file.

14. The video surveillance system of claim 13, wherein the portable memory device is a FLASH memory card.

15. A video surveillance system, the video surveillance system comprising:
a first video camera configured to independently generate a first stream of video data;
a second video camera configured to independently generate a second stream of video;
a sync and frame merge module coupled with the first and second video cameras, wherein the sync and frame merge module is configured to enable generation of the second stream of video data in substantial synchronization with generation of the first stream of video data by establishment of a constant phase relationship between the first and second streams of video data,
the sync and frame merge module also configured to switch between the first and second streams of video data on a frame-by-frame basis to generate a single contiguous stream of common video data;
a video processing module coupled with the sync and frame merge module , wherein the video processing module is configured to compress the single contiguous stream of common video data; and
a microcontroller coupled with the video processing module, wherein the microcontroller is configured to direct storage of the compressed single contiguous stream of common video data.

16. The video surveillance system of claim 15, further comprising a memory device detachably coupled with the microcontroller, wherein the memory device comprises a FLASH memory configured to store the single contiguous stream of common video data.

17. The video surveillance system of claim 15, wherein the microcontroller directs the storage of a predetermined amount of the single contiguous stream of video data in a continuous loop.

18. The video surveillance system of claim 17, wherein the video data comprises a plurality of first video frames generated by the first video camera and a plurality of second video frames generated by the second video camera, wherein the single contiguous stream of video data comprises a portion of the first video frames interleaved between a portion of the second video frames.

19. The video surveillance system of claim 15, further comprising a buffer coupled with the microcontroller and the video processing module, wherein the buffer is configured to temporarily store the single contiguous stream of common video data until the microcontroller directs storage of the single contiguous stream of common video data.

20. The video surveillance system of claim 15, further comprising a power conditioning module coupled with the microcontroller, the power conditioning module configured to indicate low supply voltage conditions to the microcontroller and maintain the supply voltage to the microcontroller above the low supply voltage condition for a determined period of time, the microcontroller configured to perform an orderly shutdown of the video surveillance system in response to indication from the power conditioning module of low supply voltage conditions.

21. The video surveillance system of claim 15, further comprising a shock sensor coupled with the microcontroller, wherein the microcontroller is configured to cease storage of the compressed single contiguous stream of common video data a determined amount of time after forces above a determined threshold are indicated by the shock sensor.

22. The video surveillance system of claim 15, wherein the constant phase relationship between the first and second streams of video data comprises one of a determined phase offset and in phase.

23. A video surveillance system comprising:
a first video camera configured to independently generate a first stream of video data;
a second video camera configured to independently generate a second stream of video data;
a camera clock coupled with the first video camera, the camera clock configured to provide a common clock signal to the first video camera to enable generation of the first stream of video data; and
a clock hold off circuit coupled with the second video camera and the camera clock, wherein the clock hold off circuit is configured to selectively enable the second video camera with the common clock signal to generate the second stream of video data in substantial synchronization with generation of the first stream of video data.

24. The video surveillance system of claim 23, further comprising a video data merger circuit coupled with the first and second video cameras, the video data merger circuit configured to merge the first and second streams of video data to form a contiguous stream of common video data.

25. The video surveillance system of claim 24, further comprising a video processing module coupled with the video data merger circuit, wherein the video processing module is configured to decode the contiguous stream of common video data into a digital form and compress the digital form of the contiguous stream of common video data to minimize data storage requirements.

26. The video surveillance system of claim 24, further comprising a video processing module coupled with the video data merger circuit, wherein the video processing module is configured to compress the contiguous stream of common video data to minimize data storage requirements.

27. The video surveillance system of claim 23, wherein the first and second video cameras are configured to independently generate the video data in analog form.

28. The video surveillance system of claim 23, wherein the first and second video cameras are configured to generate the video data in digital form.

29. A method of capturing video data from a plurality of video cameras, the method comprising:
providing a first video camera capable of generation of a first stream of video data and a second video camera capable of generation of a second stream of video data;
stopping generation of the second stream of video data until a determined condition is detected in the first stream of video data;
starting generation of the second stream of video data to generate the second stream of video data substantially synchronous with the first stream of video data when the determined condition is detected;
interleaving frames from the first stream of video data with frames from the second stream of video data to form a single contiguous stream of common video data; and
storing the single contiguous stream of common video data in a continuous loop with a determined duration.

30. The method of claim 29, wherein stopping generation of the second stream of video data comprises disabling a common clock signal from the second video camera, wherein the common clock signal also enables the first video camera.

31. The method of claim 29, wherein starting generation of the second stream of video data comprises detecting when timing information in the first stream of video is substantially the same as timing information in the stopped second stream of video data.

32. The method of claim 29, wherein storing the single contiguous stream of common video data comprises storing the single contiguous stream of common video data in a continuous loop of a determined size such that the oldest video data is overwritten by the newest video data.

33. The method of claim 29, further comprising sensing an external event; continuing to store the single contiguous stream of common video data for a determined period of time following the external event; and stopping further storage of the single contiguous stream of common video data upon expiration of the determined period of time.

34. The method of claim 29, further comprising timing for a determined period of time when an external event is sensed and ceasing further storage of the contiguous stream of common video data at the end of the determined time period.

35. The method of claim 29, wherein stopping generation of the second stream of video data comprises monitoring the first stream of video data during a clock holdoff period.
